(19) United States
(12) Patent Application Publication
(10) Pub. No.: US 2013/0272870 A1
(43) Pub. Date: Oct. 17, 2013

(54) MICA-BASED SEALS FOR GAS TURBINE SHROUD RETAINING CLIP

(71) Applicants: David Wayne Weber, Simpsonville, SC (US); Christopher Lee Golden, Greer, SC (US); Victor John Morgan, Simpsonville, SC (US); Stephen William Tesh, Simpsonville, SC (US)

(72) Inventors: David Wayne Weber, Simpsonville, SC (US); Christopher Lee Golden, Greer, SC (US); Victor John Morgan, Simpsonville, SC (US); Stephen William Tesh, Simpsonville, SC (US)

(73) Assignee: General Electric Company, Schenectady, NY (US)

(21) Appl. No.: 13/448,633

(22) Filed: Apr. 17, 2012

(51) Int. Cl. F02C 7/28; F16J 15/02

(52) U.S. Cl. 415/214.1; 277/312

(57) ABSTRACT

A gas turbine, a gas turbine shroud, and a method for sealing a gas turbine shroud with a non-metallic seal are provided. The gas turbine shroud includes an inner shroud and an outer shroud. A non-metallic seal is located between the inner shroud and the outer shroud while a shroud retainer clip applies a compression force upon the inner shroud and the outer shroud. The compression force compresses the non-metallic seal to fill a gap space between the inner shroud and the outer shroud to control fluid flow between a flow path and a non-flow path.

### STATEMENT OF GOVERNMENT-SPONSORED RESEARCH

This invention was made at least in part with government support under contract No. DE-FC26-05NT42643 awarded by the United States Department of Energy. The government has certain rights in this invention.

### BACKGROUND OF THE INVENTION

1. Field of the Invention

The invention relates to gas turbine components, and specifically relates to gas turbine shrouds and related hardware.

2. Discussion of Prior Art

It is desirable to operate a gas turbine engine at high temperatures for efficiently generating and extracting energy from these gases. Certain components of a gas turbine engine, for example stationary shroud segments and their supporting structures, are exposed to the heated stream of combustion gases. The shroud is constructed to withstand temperatures of the combustion gases within the flow path, but its supporting structures may not be and must be protected from the heated stream. In order to limit the flow of high pressure compressor bleed air from a non-flow path to a flow path, relatively tight manufacturing tolerances are maintained on corresponding surfaces of shroud segments and their supporting structures. Additionally, a positive pressure difference is maintained between the non-flow path and the flow path.

The relatively tight manufacturing tolerances leave little or no gap space between the shroud segments and their supporting structures for heated combustion gases to move from the flow path to the non-flow path. This has been an effective design, however, the relatively tight manufacturing tolerances can be both difficult and costly to manufacture. Additionally, the width of the gap space between the shroud segment and its supporting structure can lengthen and contract commensurate with the fluctuating temperatures of these components. Accordingly, there is a need for a shroud seal that can reduce the difficulty and cost to manufacture the shroud components while minimizing or eliminating the flow of compressor bleed air from the non-flow path to the flow path.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

One aspect of the invention provides a gas turbine shroud. The gas turbine shroud includes an inner shroud and an outer shroud. The gas turbine shroud further includes a non-metallic seal between the inner shroud and the outer shroud. The gas turbine shroud also includes a shroud retainer clip configured to apply a compression force upon the inner shroud and the outer shroud. The compression force compresses the non-metallic seal to fill a gap space between the inner shroud and the outer shroud and thereby controls fluid flow between a flow path and a non-flow path.

Another aspect of the invention provides a gas turbine. The gas turbine includes at least one turbine stage and at least one turbine stage includes a plurality of turbine blades. The gas turbine further includes an inner shroud, an outer shroud, and a non-metallic seal between the inner shroud and the outer shroud. The gas turbine also includes a shroud retainer clip configured to apply a compression force upon the inner shroud and the outer shroud. The compression force compresses the non-metallic seal to fill a gap space between the inner shroud and the outer shroud and thereby controls fluid flow between a flow path and a non-flow path.

Another aspect of the invention provides a method of sealing shroud elements of a gas turbine. The gas turbine includes at least one turbine stage and at least one turbine stage includes a plurality of turbine blades. The gas turbine further includes an inner shroud and an outer shroud. The method further includes providing a non-metallic seal between the inner shroud and the outer shroud. The method also includes applying a compression force acting upon the inner shroud and the outer shroud to compress the non-metallic seal to fill a gap space between the inner shroud and the outer shroud and thereby control fluid flow between a non-flow path to a flow path.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a cross-sectional view of an example gas turbine section incorporating the shroud seal of the present invention;

FIG. 2 is an enlarged view of a portion of a shroud assembly from the example gas turbine section of FIG. 1;

FIG. 3 is a partial cross-sectional schematic view taken along lines 3-3 of FIG. 2; and

FIG. 4 is a top level flow diagram of an example method of sealing shroud elements of a gas turbine.

### DETAILED DESCRIPTION OF THE INVENTION

Example embodiments that incorporate one or more aspects of the invention are described and illustrated in the drawings. These illustrated examples are not intended to be a limitation on the invention. For example, one or more aspects of the invention can be utilized in other embodiments and even other types of devices. Moreover, certain terminology is used herein for convenience only and is not to be taken as a limitation on the invention. Still further, in the drawings, the same reference numerals are employed for designating the same elements.

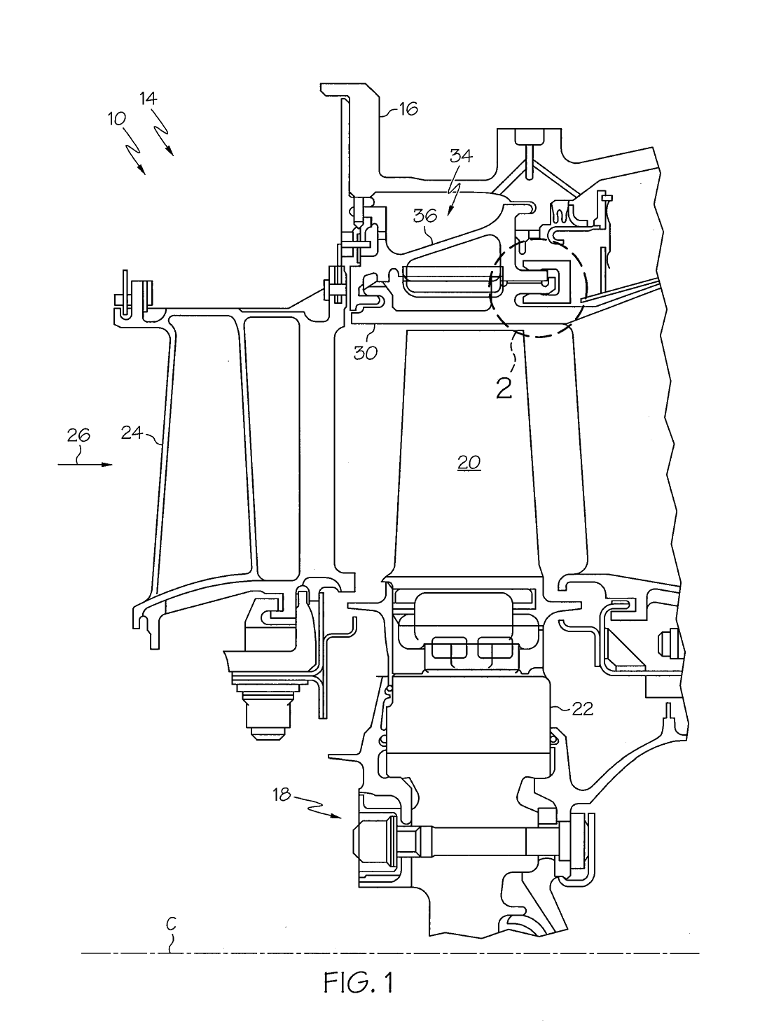

A schematic rendering an example gas turbine 10 is generally shown in FIG. 1. It is to be appreciated that FIG. 1 shows one example of possible structures/configurations/etc. and that other examples are contemplated within the scope of the present invention. In one specific example, the gas turbine 10 can be a gas turbine jet engine used to propel an airplane. In another specific example, the gas turbine 10 can be an industrial gas turbine for power generation. The gas turbine 10 can include a compressor with a number of compressor stages (not shown), a combustion chamber (not shown), and a turbine section 14 disposed within an engine casing 16. As shown in FIG. 1, the gas turbine 10 includes a turbine section 14 of one turbine stage, although different numbers of turbine stages are possible. The turbine stage shown in FIG. 1 can be termed the first stage. The first stage can include a first stage rotor 18 with a plurality of circumferentially spaced-apart first stage blades 20 extending radially outwardly from a first stage disk 22 that rotates about the centerline axis “C” of the engine, and a stationary first stage turbine nozzle 24 for channeling combustion gases into the first stage blades 20. Subsequent stages in the turbine section 14 can include similar structure. This is a simplified description, and it is to be understood that conventional gas turbines and the example gas turbine 10 can have many more operating components than those described above.

Combustion gases enter the turbine section 14 from an upstream combustion chamber (not shown) in the direction shown by arrow 26. Combustion gases can be of relatively high temperature, and it is desirable to maintain the combustion gases within a particular flow path for at least several reasons. One reason to maintain the combustion gases within a particular flow path is to improve efficiency by ensuring the flowing combustion gases impinge upon the first stage blades 20, thereby turning the turbine shaft. Another reason to maintain the combustion gases within a particular flow path is that support structures outside of the gas turbine 10 may not be designed to withstand the relatively high temperature of the combustion gases as they pass through the gas turbine 10.

In order to maintain the combustion gases within the desired flow path, a plurality of cylindrically curved, or arcuate, first stage inner shrouds 30 are arranged circumferentially in an annular array so as to closely surround the first stage blades 20. The inner shrouds 30 define the outer flow path boundary for the hot combustion gases flowing through the first stage rotor 18. Thus, the flow path can be generally described as the volume between the inner shrouds 30 and the inner walls of the first stage blades 20 and the first stage turbine nozzle 24 (excluding rotor wheel spaces). A non-flow path can be generally described as the volume exterior of the inner shrouds 30. The first stage inner shrouds 30 and their supporting hardware can be termed a “shroud assembly” 34. It is to be appreciated that the description of the first stage inner shrouds 30 and the shroud assembly 34 are equally applicable to any stage of the gas turbine 10.

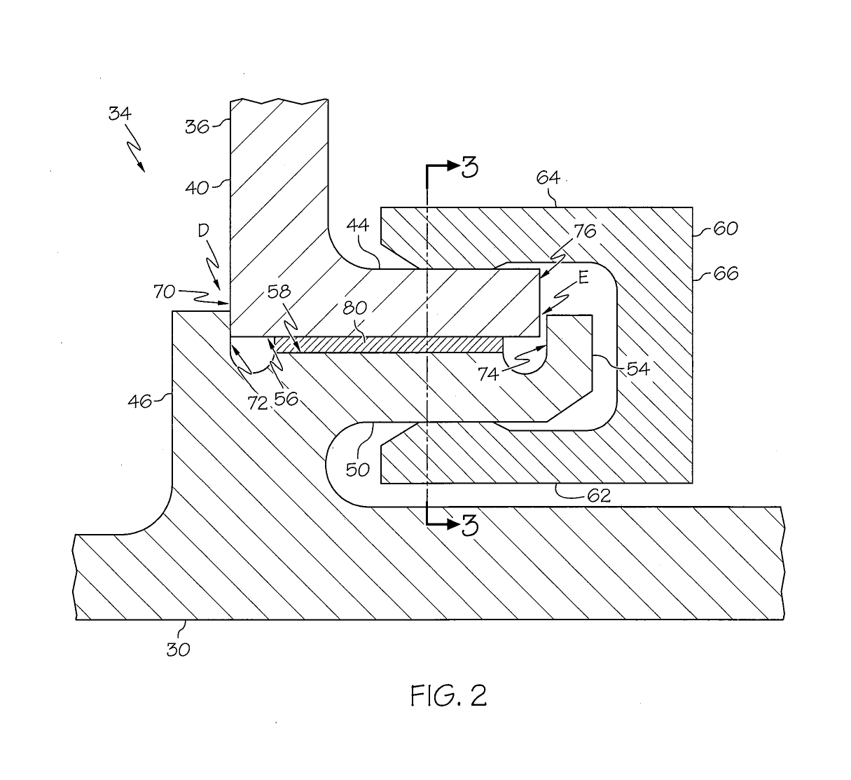

FIG. 2 is an enlarged view of a portion of an example shroud assembly 34. A supporting structure referred to as an outer shroud 36 is mounted to the engine casing 16 (best seen in FIG. 1) and retains the first stage inner shroud 30 to the engine casing 16. The outer shroud 36 is generally arcuate and has a radially extending arm 40. The outer shroud 36 can be a single continuous 360° component, or it may be segmented into a plurality of arcuate segments. An arcuate hook 44 extends axially from the arm 40. Each inner shroud 30 includes an arcuate base 46 having an axially extending rail 50. A mounting flange 54 extends rearwardly from the rail 50 of each inner shroud 30. The inward facing surface 56 of the arcuate hook 44 and the outward facing surface 58 of the rail 50 can be considered annular mating surfaces, although there can be a gap between the arcuate hook 44 and the rail 50. The rail 50 of each inner shroud 30 is located adjacent the arcuate hook 44 of the outer shroud 36 and is held in place by a plurality of retaining members referred to as shroud retainer clips 60.

The shroud retainer clips 60 are arcuate members and can have a C-shaped cross section with inner arms 62 and outer arms 64 that overlap the mounting flanges 54 and the arcuate hooks 44. The shroud retainer clips 60 clamp the aft ends of the inner shrouds 30 in place against the outer shrouds 36 by providing a compression force applied to the inner shroud 30 and the outer shroud 36. The inner arms 62 and the outer arms 64 are joined by an arcuate, radially extending flange 66. While they could be formed as a single continuous ring, the shroud retainer clips 60 are typically segmented to form a plurality of shroud retainer clips 60. Segmentation of the shroud retainer clips 60 can accommodate thermal expansion as the combustion gases heat the inner shrouds 30, the shroud retainer clips 60, and the outer shrouds 36. Typically, each shroud retainer clip 60 clamps on at least one inner shroud 30. The shroud retainer clips 60 can be press fit into place ensuring a compressive fit.

As mentioned previously, it is often advantageous to maintain the flow of combustion gases within the flow path within the substantially cylindrical volume defined by the inner shroud 30. One way to limit the escape of combustion gases is to maintain relatively tight manufacturing tolerances between mating surfaces of the inner shrouds 30 and the outer shrouds 36. For example, an arm forward surface 70 can be manufactured to a relatively tight tolerance to mate with a rail aft surface 72 which can also be manufactured to a relatively tight tolerance. The interface between the arm forward surface 70 and the rail aft surface 72 can be referred to as interface D. In another example, the mounting flange forward surface 74 can be manufactured to a relatively tight tolerance to mate with the arm aft surface 76 which can also be manufactured to a relatively tight tolerance. The interface between the mounting flange forward surface 74 and the arm aft surface 76 can be referred to as interface E. During operation of the gas turbine 10, some compressor bleed flow (high pressure) can enter the flow path by passing through interface D, flowing between the arm 40 and the mounting flange 54, and passing through interface E. The relatively tight manufacturing tolerances of interface D and interface E help limit the quantity of compressor bleed leaking to the flow path. In some gas turbine 10 applications, interface D, interface E, or both may be manufactured to relatively tight tolerances in order to limit the loss of compressor bleed to the flow path.

Leakage of compressor bleed to the flow path of the gas turbine 10 can have several undesired effects on the performance of the gas turbine 10. Loss of combustion gases from the flow path can reduce efficiency of the gas turbine 10. Moreover, if the cavities surrounding the flow path do not remain pressurized, combustion gases can escape the flow path and provide undesired heat to the outer shroud 36, the engine casing 16, and other components which may not be designed to withstand relatively high heat. A tight assembly gap resulting from relatively tight manufacturing tolerances for interfaces D and E helps to minimize the leakage and maintain pressurized cavities. However, these relatively tight manufacturing tolerances can be both difficult to produce and costly to produce. Additionally, the relatively tight gap between these surfaces at a cold (i.e., room temperature) assembly condition can be negatively affected by the expansion and contraction of the turbine components. The expansion and contraction can occur as the operating temperatures of the gas turbine 10 are attained during normal operation. This expansion and contraction make it more difficult to maintain acceptable leakage gaps for a hot (i.e., turbine operating temperature) condition.

A non-metallic seal 80 is located between the inner shroud 30 and the outer shroud 36. In a more specific example, the non-metallic seal 80 can be located between the annular mating surfaces of the mounting flange 54 of the inner shroud 30 and the arcuate hook 44 of the outer shroud 36. The shroud retainer clip 60 is configured to apply a compression force upon the inner shroud 30 and the outer shroud 36 to compress the non-metallic seal 80 and thereby control fluid flow of leakage to the flow path from the non-flow path. The non-metallic seal 80 fills the gap between the between the arm 40 of the outer shroud 36 and the mounting flange 54 of the inner shroud 30. In one example, the non-metallic seal 80 provides an airtight seal between the inner shroud 30 and the outer shroud 36 to limit or eliminate leakage to the flow path from the non-flow path.

In one example, the non-metallic seal 80 is at least partially composed of mica. Mica can be an ideal material for this application due to its physical properties having an amount of pliability and the ability to be compressed. Materials at least partially composed of mica can also exhibit both heat and chemical resistance. Additionally, materials at least partially composed of mica can expand with increased temperature. As the inner shroud 30 and outer shroud 36 components expand and contract with changing temperature, the non-metallic seal 80 can expand and contract, tending to fill the gap space between the inner shroud 30 and the outer shroud 36 even as that gap space expands and contracts. One example of a material at least partially composed of mica is Thermiculite®, manufactured by The Flexitallic Group, Inc.

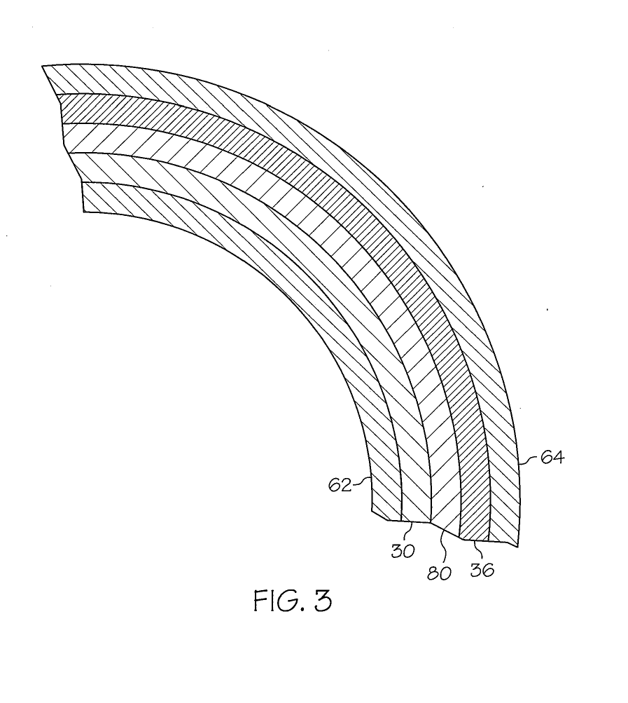

In another example, the non-metallic seal 80 can include a sheet material. The sheet material can be relatively flat, having relatively large width and length dimensions in comparison to a relatively small thickness dimension. The sheet can be a continuous loop of non-metallic material, or it can be segmented into a plurality of arcuate segments. The sheet of non-metallic seal 80 can be applied with an adhesive to the outer shroud 36 during the gas turbine 10 assembly or rebuild process at a cold assembly condition. After the non-metallic seal 80 is applied to the outer shroud 36, the inner shroud 30 can be breech loaded into the gas turbine 10. The shroud retainer clips 60 can then be applied to create a compression force effectively sandwiching the non-metallic seal the between the outer shroud 36 and the inner shroud 30. In another example, the non-metallic seal 80 can be cylindrically curved and coaxially centered on the centerline axis C of the gas turbine 10. FIG. 3 is an enlarged view of the circumferential relationship of the shroud retainer clip 60, the outer shroud 36, the non-metallic seal 80, and the inner shroud 30.

FIG. 3 is an enlarged cross-sectional view schematically showing the circumferential relationship of the shroud retainer clip 60, the outer shroud 36, the non-metallic seal 80, and the inner shroud 30. The shroud retainer clip 60 includes inner arm 62 and outer arm 64. The thickness of the non-metallic seal 80 can be selected to provide a predetermined clamping force applied by the shroud retainer clip 60 to the outer shroud 36 and the inner shroud 30.

Returning to FIG. 2, while it is not necessary, the non-metallic seal 80 located between the inner shroud 30 and the outer shroud 36 can enable at least one manufacturing tolerance of a surface on the inner shroud 30 to be increased in limit. For example, because the non-metallic seal 80 can limit the leakage from the non-flow path to the flow path, the design of the outer shroud 36 and the inner shroud 30 can rely less upon the relatively tight manufacturing tolerances for interfaces D and E to limit the leakage from the non-flow path to the flow path. The increased limits of the manufacturing tolerances can decrease both the difficulty and the cost of manufacturing for the outer shroud 36 and the inner shroud 30. It is to be appreciated that this increase in manufacturing tolerances to decrease the difficulty and cost of manufacturing may need to be balanced with the benefit of limited motion of the inner shroud 30 relative to the outer shroud 36 resulting from relatively tight manufacturing tolerances.

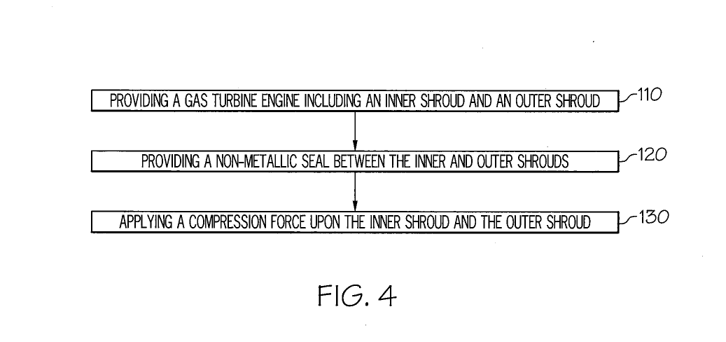

An example method of sealing shroud elements of a gas turbine is generally described in FIG. 4. The method can be performed in connection with the example gas turbine components of FIG. 1. The method includes the step 110 of providing a gas turbine. The gas turbine includes at least one turbine stage, and each turbine stage includes a plurality of turbine blades, an inner shroud, and an outer shroud. The gas turbine can be one of any number of commercially available gas turbines.

The method also includes the step 120 of providing a non-metallic seal between the inner shroud and the outer shroud. In one example of the method, the non-metallic seal is provided between the annular mating surfaces of the inner shroud and the outer shroud. In another example of the method, the non-metallic seal is at least partially composed of mica. The non-metallic seal can be formed of a sheet material. Additionally, the non-metallic seal can be cylindrically curved and can be coaxially centered on the centerline axis of the gas turbine.

The method further includes the step 130 of applying a compression force acting upon the inner shroud and the outer shroud to compress the non-metallic seal and thereby control fluid flow between a non-flow path to a flow path. In one example of the method, the compression force can be supplied by shroud retainer clips which are sometimes known as C-clips. In one example of the method, the presence of the non-metallic seal enables at least one manufacturing tolerance of a surface on the inner shroud to be increased in limit.

The described non-metallic seals for gas turbine shrouds and the associated method for their use provide several benefits. The mica-based seal provides a relatively low cost alternative to preventing leakage of compressor bleed air between the outer shroud and the inner shroud when compared to the relatively tight manufacturing tolerances that are often machined into corresponding surfaces of the shroud elements. Additionally, the non-metallic seal can expand and contract during the heating and cooling periods of the gas turbine components, tending to seal the gap between the outer shroud and the inner shroud, whereas the known method of incorporating relatively tight manufacturing tolerances in the shroud elements creates a changing width of the gap space under fluctuating temperature conditions. Use of the non-metallic seal between the horizontal surfaces of outer shroud and the inner shroud can reduce chargeable flow. Chargeable flow is the required cooling medium (e.g., compressor bleed air) for proper operation of the gas turbine. Additionally, because there is a compressive fit between the inner shroud, the outer shroud, and the non-metallic seal, if the non-metallic seal should fail, it will tend to remain in place and not separate from the shroud components.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A gas turbine shroud including:
an inner shroud;
an outer shroud;
a non-metallic seal between the inner shroud and the outer shroud; and
a shroud retainer clip configured to apply a compression force upon the inner shroud and the outer shroud to compress the non-metallic seal to fill a gap space between the inner shroud and the outer shroud and thereby control fluid flow between a non-flow path and a flow path.

2. The gas turbine shroud according to claim 1, wherein the non-metallic seal is placed between an annular mating surface of the inner shroud and an annular mating surface of the outer shroud.

3. The gas turbine shroud according to claim 2, wherein the non-metallic seal is further placed between a radial mating surface of the inner shroud and a radial mating surface of the outer shroud.

4. The gas turbine shroud according to claim 1, wherein the non-metallic seal is at least partially composed of mica.

5. The gas turbine shroud according to claim 4, wherein the non-metallic seal includes a sheet material.

6. The gas turbine shroud according to claim 1, wherein the non-metallic seal is cylindrically curved and is coaxially centered on the centerline axis of the gas turbine.

7. The gas turbine shroud according to claim 1, wherein the presence of the non-metallic seal enables at least one manufacturing tolerance of a surface on the inner shroud to be increased in limit.

8. A gas turbine including:
at least one turbine stage, wherein at least one turbine stage includes a plurality of turbine blades;
an inner shroud;
an outer shroud;
a non-metallic seal between the inner shroud and the outer shroud; and
a shroud retainer clip configured to apply a compression force upon the inner shroud and the outer shroud to compress the non-metallic seal to fill a gap space between the inner shroud and the outer shroud and thereby control fluid flow between a flow path and a non-flow path.

9. The gas turbine according to claim 8, wherein the non-metallic seal is placed between an annular mating surface of the inner shroud and an annular mating surface of the outer shroud.

10. The gas turbine according to claim 9, wherein the non-metallic seal is further placed between a radial mating surface of the inner shroud and a radial mating surface of the outer shroud.

11. The gas turbine according to claim 8, wherein the non-metallic seal is at least partially composed of mica.

12. The gas turbine according to claim 11, wherein the non-metallic seal includes a sheet material.

13. The gas turbine according to claim 8, wherein the non-metallic seal is cylindrically curved and is coaxially centered on the centerline axis of the gas turbine.

14. The gas turbine according to claim 8, wherein the presence of the non-metallic seal enables at least one manufacturing tolerance of a surface on the inner shroud to be increased in limit.

15. A method of sealing shroud elements of a gas turbine including:
providing a gas turbine including:
at least one turbine stage, wherein at least one turbine stage includes a plurality of turbine blades;
an inner shroud;
an outer shroud;
providing a non-metallic seal between the inner shroud and the outer shroud; and
applying a compression force acting upon the inner shroud and the outer shroud to compress the non-metallic seal to fill a gap space between the inner shroud and the outer shroud and thereby control fluid flow between a non-flow path to a flow path.

16. The method according to claim 15, wherein the non-metallic seal is provided between the annular mating surfaces of the inner shroud and the outer shroud.

17. The method according to claim 15, wherein the non-metallic seal is at least partially composed of mica.

18. The method according to claim 17, wherein the non-metallic seal includes a sheet material.

19. The method according to claim 15, wherein the non-metallic seal is cylindrically curved and is coaxially centered on the centerline axis of the gas turbine.

20. The method according to claim 15, wherein the presence of the non-metallic seal enables at least one manufacturing tolerance of a surface on the inner shroud to be increased in limit.
